(19) United States
(12) Patent Application Publication
(10) Pub. No.: US 2008/0124562 A1
(43) Pub. Date: May 29, 2008

(54) Envelope Made From Fnatural Dried Skins And Method For Production Thereof

(76) Inventors: Christian Billon-Lanfrey, Tanger (MA); Luc Mathet, Tanger (MA)

Correspondence Address: CANTOR COLBURN, LLP, 20 Church Street, 22nd Floor, Hartford, CT, 06103, US

(21) Appl. No.: 10/558,971

(22) PCT Filed: Jun. 8, 2004
(86) PCT No.: PCT/FR04/01414

§ 371 Date: Aug. 17, 2007

(30) Foreign Application Priority Data
Jun. 11, 2003 (FR) 03/07011

(51) Int. Cl. B32B 9/02

(52) U.S. Cl. 428/473; 156/195

(57) ABSTRACT

The invention relates to an envelope (9) made from natural dried skins for use in curing, comprising strips of natural skin of indeterminate diameter, quality and length respectively, previously divided longitudinally to form said strips, characterised in comprising: an inner layer made from a spiral rolling of one or several first strips one after the other, said first strips overlapping a part of each other over the length thereof and at the respective ends thereof and an outer layer (10) glued to the inner layer comprising second strips (6) arranged longitudinally on the inner layer, said second strips extending in part over each other over the lengths thereof and at the respective ends thereof. The invention further relates to the method for production of such an envelope.

### BACKGROUND OF THE INVENTION

The present invention relates to a casing made of dried natural tubing for use in curing on a cottage-industry and industrial scale and to its method of manufacture.

In curing, the casings of products need preferably to have a bore size, or diameter, a thickness, a length and a robustness all of which are constant. While artificial casing tubing often exhibits such characteristics, it is more difficult to obtain casings based on natural tubing that meets this criteria. Now, it is important to have available casings made of natural tubing for certain particular products such as products that enjoy an “appellation contrôlée” status for example.

One of the problems encountered in the manufacture of casings from natural tubing is due to the wide disparity between the lengths of natural tubing that can be used, in terms of their respective diameter, quality and length.

### DESCRIPTION OF THE PRIOR ART

When lengths of tubing of determined diameter or quality but of arbitrary length are available, one solution is to slip the lengths of tubing over a support of suitable shape, one after another, with their respective ends overlapping, then leave them to dry and demold the casing obtained. However, such a solution is not entirely satisfactory because when the diameter of the lengths of tubing prior to drying exceeds that of the support, there is a risk that, when the dried casing is rehydrated, it will regain a diameter greater than the desired diameter. It is then necessary to use water-repellant additives in order to avoid this growth in diameter.

Another solution is to dry each length of natural tubing on a suitable support then to cut it open to form a sheet. These sheets are then stitched together to reconstitute a casing of the desired length and diameter. This solution is not entirely satisfactory particularly owing to the presence of the sewing thread. Indeed, the strength of the casing is weakened in the regions of the seams. Furthermore, for cost reasons, cotton sewing thread is generally preferred over sewing thread made of natural tubing, and the product can then no longer enjoy its “appellation contrôlée” status.

In order to avoid the use of a sewing thread, it has also been proposed for lengths of natural tubing to be slit open along their length to obtain strips and for these strips to be placed over a support of suitable shape with the strips overlapping each other. After drying, the casing obtained is demolded. However, the casings thus obtained have an instability in diameter when rehydrated. Furthermore, it is often necessary to use adhesives, such as collagen, in order to assemble the strips that have to be placed over the support.

### SUMMARY OF THE INVENTION

The present invention sets out to remedy the above problems by proposing a casing made of dried natural tubing consisting of strips of natural tubing of any respective diameter, quality and length, previously slit open longitudinally, these strips being arranged in such a way that the casing obtained exhibits characteristics similar to those of artificial casings, namely a diameter, a quality and a length all of which are constant.

The subject of the present invention is a casing made of dried natural tubing, for use in curing, consisting of strips of natural tubing of any respective diameter, quality and length, previously slit open longitudinally in order to form said strips, and which comprises:
an inner layer made up of a spiral winding of one or of several first strips one after another, these first strips partially overlapping themselves along their length and each other at their respective ends, and
an outer layer bonded to the inner layer and consisting of second strips arranged longitudinally over the inner layer, these second strips partially overlapping each other along their lengths and their respective ends.

The casing according to the invention has characteristics similar to those of the artificial casings used in curing. Thus, it has a quality, particularly a robustness and a porosity, a length and a diameter all of which are constant. After rehydration, it can be used in curing in the same way as a fresh casing. The special way in which the strips of tubing are assembled within the casing, namely in a first layer of spiral-wound strips and a second layer of longitudinal strips, gives the casing its diametral stability when rehydrated.

In a preferred embodiment of the invention, the second strips overlap each other in the fashion of scales, the rear end of one said second strip covering the front end of a preceding said second strip. Such a casing in which the second strips overlap in the manner of scales is particularly advantageous for use in curing on an industrial scale. This is because the passage of the casing through “automatic hand” retarding systems, stuffer systems and “clipping” machines used in curing on an industrial scale is made easier by the scale overlap of the strips of the outer layer, the machines naturally progressing from contact with one strip to the next without rubbing any of these strips in the wrong direction.

Another subject of the present invention is a method for manufacturing a casing in dried natural tubing, as described hereinabove, and which comprises the following steps:
a) strips of natural tubing are prepared from lengths of fresh or hydrated desalted natural tubing, of any respective diameter, quality and length, that are slit open longitudinally,
b) a first layer of one or several first strips is arranged on an appropriate support, winding these strips in a spiral on the support one after another in such a way that these first strips partially overlap themselves along their length and each other at their respective ends,
c) a second layer of second strips is arranged on this first layer, placing these second strips longitudinally on the first layer in such a way that these second strips partially overlap each other along their length and their respective ends,
d) the two layers are left to dry on the support,
e) the casing obtained is removed from the support.

Advantageously, the second strips are placed in such a way that they overlap in the fashion of scales, the rear end of one said second strip covering the front end of a preceding said second strip.

By virtue of the method according to the invention, it is possible to manufacture a casing in dried natural tubing that has characteristics similar to the characteristics of artificial casings, namely a diameter, a quality and a length all of which are constant, from initial natural tubings exhibiting different diameters, qualities and lengths. Thus, it is possible to use lengths of tubing of short length, low quality and any diameter from which to manufacture a dried casing which will have a quality, a length and a diameter all of which are constant.

Specifically, in the casing according to the invention, the superposition of the two specific, inner and outer, layers eliminates the problems of porosity and robustness. In addition, according to the method of the invention, the strips of tubing are positioned on the support in the hydrated state and the drying of these strips, in situ on the support, allows the strips to be made to stick together with no adhesive and no additive. This drying also allows the outer layer to be made to stick to the inner layer without adhesive or additive.

### BRIEF DESCRIPTION OF THE DRAWINGS

The invention will be better understood with the aid of the attached drawing in which:

FIGS. 1 and 2 show the step of preparing the inner layer of the casing according to the invention,

FIGS. 3 to 5 show the step of producing the outer layer of the casing according to the invention, the strips of the outer layer overlapping in the manner of scales.

### DESCRIPTION OF THE PREFERRED EMBODIMENT

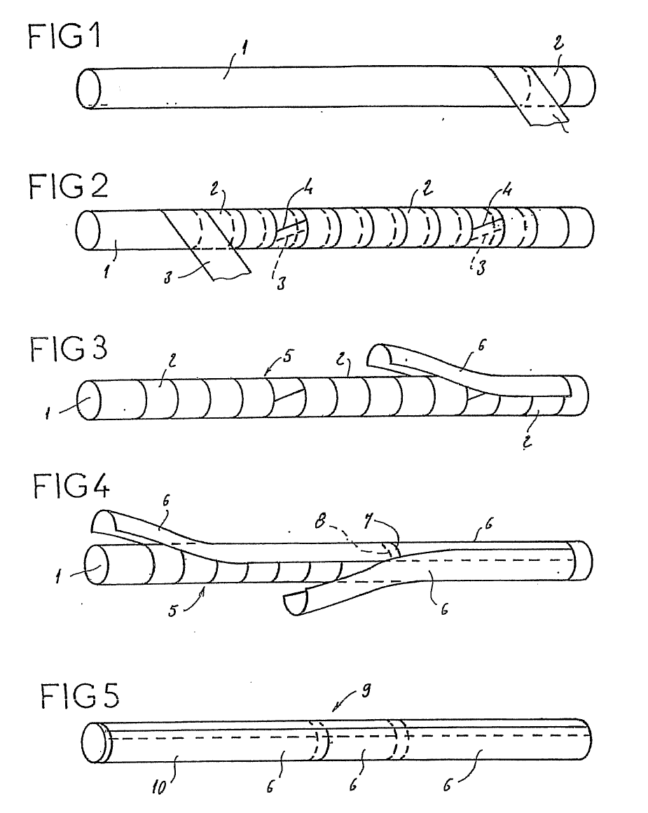

FIG. 1 depicts a support 1 onto which a first strip 2 is spiral wound, this strip partially overlapping itself along its length. This strip was obtained from a length of fresh or desalted natural tubing that had been slit open longitudinally. This strip 2 is wound onto the support 1 in the hydrated state. This strip 2 has a front end 3.

FIG. 2 shows the support 1 of FIG. 1 on which two other strips 2 have been wound, following on from the first. The rear end 4 of each strip 2 covers the front end 3 of the previous strip 2 in such a way that the respective ends of the strips 2 overlap. These various strips 2 may be of different widths, qualities or lengths.

FIG. 3 depicts a fully formed inner layer 5. This inner layer 5 consists of three first strips 2 spiral wound onto the support 1 one after another. A strip 6 is in the process of being installed, in a longitudinal arrangement, on the inner layer 5. This strip 6 was obtained from lengths of fresh or desalted natural tubing in the same way as the strips 2.

FIG. 4 shows the installation, in a longitudinal arrangement, of two further strips 6, on the inner layer 5, in such a way that these strips 6 partially overlap each other along their length and at their respective ends. Thus, the rear end 7 of a strip 6 covers the front end 8 of the previous strip 6. The various strips 6 thus overlap in the manner of scales. The various strips 6 may be of different widths, qualities or lengths.

FIG. 5 depicts a casing 9 according to the invention on a support 1. The outer layer 10 is completely formed of strips 6 arranged longitudinally on the inner layer in such a way that these strips 6 entirely cover the inner layer of the casing.

After drying on the support, all that is required is for the casing obtained to be demolded in order to have available a casing made of dried natural tubing ready for use. Thus, after rehydration, this casing can be used in the same way as a fresh casing in curing. This casing has characteristics similar to those of artificial casings. In particular, the casing according to the invention has a diameter, a quality and a length all of which are constant. The special way in which the strips of tubing are assembled within the casing, namely in a first layer of spiral-wound strips and a second layer of longitudinal strips ensures the diametral stability of the casing when rehydrated.

1. A casing made of dried natural tubing, for use in curing, including strips of natural tubing of any respective diameter, quality and length, previously slit open longitudinally in order to form said strips, and said casing comprising:
an inner layer made up of a spiral winding of one or of several first strips one after another, these first strips partially overlapping themselves along their length and each other at their respective ends, and
an outer layer bonded to the inner layer and consisting of second strips arranged longitudinally over the inner layer, these second strips partially overlapping each other along their lengths and their respective ends.

2. The casing as claimed in claim 1, wherein the second strips overlap each other in the fashion of scales, the rear end of one said second strip covering the front end of a preceding said second strip.

3. A method of manufacturing a casing in dried natural tubing as claimed in claim 1 comprising:
a) preparing strips of natural tubing from lengths of fresh or hydrated desalted natural tubing, of any respective diameter, quality and length, that are slit open longitudinally,
b) arranging a first layer of one or several first strips on an appropriate support, winding these strips in a spiral on the support one after another in such a way that these first strips partially overlap themselves along their length and each other at their respective ends,
c) arranging a second layer of second strips on this first layer, placing these second strips longitudinally on the first layer in such a way that these second strips partially overlap each other along their length and their respective ends,
d) leaving the two layers to dry on the support,
e) removing the casing obtained from the support.

4. The method as claimed in claim 3, wherein the second strips are placed in such a way that they overlap in a fashion of scales, the rear end of one said second strip covering the front end of a preceding said second strip.
